(19) United States
(12) Patent Application Publication
(10) Pub. No.: US 2001/0050323 A1
(43) Pub. Date: Dec. 13, 2001

(54) Parachute opening apparatus

(76) Inventor: David B. Brownell, Mesa, AZ (US)

Correspondence Address: David B Brownell, 706 West Pampa Avenue, Mesa, AZ, 85210-8317, US

(21) Appl. No.: 09/746,057

(22) Filed: Mar. 12, 2001

Related U.S. Application Data
(60) Provisional application No. 60/173,067, filed on Dec. 24, 1999.

(51) Int. Cl. B64D 17/00; B64D 19/00; B64D 21/00; B64D 23/00

(52) U.S. Cl. 244/142

(57) ABSTRACT

An improved parachute and parachute deployment slider is disclosed. Embodiments of the improved slider seek to reduce slider rebound and more properly stage parachute deployment, particularly the deployment of ram air parachutes weighing two to fifteen pounds. One slider comprises of a rectangular fabric slider body with relatively lightweight grommets mounted adjacent each of the four corners on the slider. Another slider has relatively lightweight suspension line rings mounted externally from the slider fabric body at the corners of a rectangular slider body. One embodiment of the preferred parachute has a relatively smaller and lightweight pilot chute as well as relatively less elastic suspension lines at the slider stop positions on the parachute.

### FIELD OF THE INVENTION

This invention relates to parachute opening apparatus. More specifically, this invention relates to apparatus for achieving properly staged parachute openings, preferably with reduced likelihood of malfunction or hard opening shock for the person or article to be decelerated by the parachute and the opening apparatus.

### CROSS REFERENCE TO RELATED APPLICATION

This application claims priority through the applicant's prior provisional patent application, Ser. No. 60/173,067, filed Dec. 24, 1999, entitled “Parachute Opening Apparatus,” the entire disclosure of which the applicant hereby incorporates herein by reference.

### BACKGROUND

The parachute industry has long sought to develop reliable, long lasting, economical, adaptable, lightweight, and versatile parachutes. The earliest parachute technologies provided wing shaped technologies. Later, round parachutes became the dominant technology utilized not only in general aviation and sport parachuting, but also in aerospace applications.

In or about the late-1970's, however, sport parachutests began using ram-air parachutes. Today, ram air parachutes are dominant in sport parachuting and in other applications as well, including military and aerospace applications.

Although ram-air parachutes can be highly reliable, relatively lightweight, adaptable, long lasting, and versatile, prior art ram air parachutes suffer from the problem of excessively rapid and sometimes improperly staged openings. This is predominantly because the ram air canopy can (i) commence inflation too early in the deployment process (before full extension of the suspension lines, for example), and (ii) open too rapidly and erratically. Unless the opening of this type of parachute is carefully staged and slowed down in some fashion, the improperly staged and unduly rapid openings can impose large G forces (i.e., opening shock) on the person or article being decelerated by the parachute. This type of opening shock not only can be uncomfortable and aggravating to a person being decelerated in this fashion, but also can do physical harm to the person or article subjected to the shock.

One widely used device utilized to try to solve these types of problems is the rectangular suspension line slider. This slider typically consists of a rectangular section of ripstop parachute fabric with peripheral nylon or other fabric web reinforcement and metal grommets at each corner of the slider. This type of prior art rectangular slider typically has brass or stainless steel grommets and weighs at least five to six ounces when used in conjunction with the typical lightweight sport parachute ram-air canopy assembly (canopy, suspension lines, slider stops, and packing bag), which commonly weigh at least five to six pounds but can weigh as little as approximately two pounds and as much as approximately fifteen pounds. This rectangular type of slider can, however, increase in weight, due to the use of heavier and bulkier components, when used with larger and heavier canopy assemblies, such as the larger tandem (dual skydiver) sport parachuting canopies which often weigh approximately ten to fifteen pounds.

The rectangular prior art slider is mounted on the suspension lines of the ram-air parachute so that it can slide down them. (Such as shown in FIG. 1). Typically, the parachute is then packed with the slider at the top of the suspension lines immediately adjacent the slider stop rings secured to the bottom surface of the ram air canopy adjacent four suspension lines connected to the bottom of the canopy. On deployment of the parachute, after the suspension lines have extended and the ram air parachute commences to open, the parachute must force the relatively smaller slider to slide down the suspension lines. Since, particularly after the parachute commences to open, the rectangular slider is forced toward the parachute by air (relative wind) rushing against the rectangular slider toward the parachute canopy, the rectangular slider creates a substantial resistance to rapid opening of the parachute canopy. The parachute canopy thus cannot fully inflate and deploy until the inflation forces (such as relative wind rushing into the cells of a ram air canopy) force the canopy to commence inflation and thus the suspension lines to spread, which in turn force the rectangular slider down the suspension lines and against the resistance imposed by relative wind. The interaction of the opening parachute, the suspension lines, and the rectangular slider resisting the deployment does achieve substantial slowing down of the opening while also accomplishing a more staged and orderly deployment, particularly for the ram-air type of parachute.

Notwithstanding the effectiveness of the prior art rectangular slider and staging at slowing ram air parachute openings, parachutists using these devices still have long faced significant deployment problems such as excessive opening shocks, and erratic occurrence of such shocks, as well as erratic and unsafe occurrence of deployment malfunction. One solution has been to utilize a smaller pilot chute in order to reduce the level of drag created by the pilot chute, and slow down the speed of deployment of the entire parachute assembly. A smaller pilot chute can help slow down an opening, but reduction of the size of the pilot chute by itself does not ensure that the slider deploys properly or that the ram air parachute deploys in the proper order after the suspension lines have extended. As a result, smaller pilot chutes can help but do not eliminate the problem of excessive or erratic opening shock.

One attempt at making a slider has been what is called the “spider slider.” This slider consisted only of the four metal grommets interconnected by crossed, relatively narrow strips of material or other material. The problem that this slider brought about was the excessive reduction in surface area of the slider material and the concomitantly greatly reduced drag of the spider slider against the relative wind and the corresponding reduced resistance to opening of the parachute. The spider slider thus has not been effective at effectively slowing down or properly staging parachute openings.

Another attempt at making the slider more effective has been to secure the center of the slider to the tail of the ram-air parachute with a rubber band. These prior art methods can help ensure that the slider begins its downward descent no earlier than desired, but they can involve risks of unduly slowing openings, creating entanglements and preventing openings, etc. They are also not reliable due the complicated and highly variable aerodynamics of high speed parachute deployments and openings.

The applicant has discovered that these prior art devices and techniques suffer from a failure to appreciate the true nature of, and the problems occurring during, a parachute opening, particularly that of a very rapidly opening parachute, such as a ram air parachute. The applicant has discovered that, as shown in the schematic of FIG. 9, one significant problem causing or aggravating parachute opening shocks is the problem of “slider rebound,” which takes place during and immediately (typically in a matter of relatively few milliseconds) after suspension line extension and just prior to opening of the parachute. The applicant has discovered that, as a result of this slider rebound, the slider 1 moves down the slider stop suspension lines 2 toward the suspended skydiver (not shown in FIG. 9) and away from the parachute slider stops 3, 4, 5, 6. The applicant has therefore discovered that the slider 1 is out of position—separated by an undesirable distance U from the slider stops 3, 4, 5, 6—due to this rebound (prior to canopy 7 exit from the bag 11 and inflation of the canopy 7) resulting in reduced ability of the slider to properly slow and stage the opening of the canopy 7 as it separates vertically from the skydiver due to the drag imposed by the pilot chute 8.

The applicant has further discovered that there are also a variety of factors involved in causing slider rebound and in otherwise causing undesirable opening shock and canopy deployment. For example, prior art ram air parachutes typically have suspension lines that are all comprised of the same material. It also has become common in the prior art to use relatively elastic suspension lines, such as Spectra/Microline and Vectran. The applicant has discovered that use of these types of identical, and particularly the use of relatively elastic suspension lines, contributes to excessive slider rebound and thereby improper staging, unduly rapid deployment of the canopy, and excessive opening shock.

The applicant also has discovered that prior art solid body rectangular sliders suffer from having tension distributed improperly within the periphery of the slider rather than all across the slider fabric to the outermost peripheral edge of the slider fabric. The applicant has discovered that this is because, in the typical prior art solid body slider, the suspension line grommets are mounted within a grommet passage in the fabric spaced substantially inwardly from the periphery of the rectangular slider fabric. As a result, the tension applied across the fabric by the suspension lines and grommets during parachute deployment is spaced inwardly from the periphery of the fabric. The applicant has discovered that this causes the typical prior art rectangular slider not only to include an excessive amount of fabric and accompanying fabric weight but also to operate somewhat improperly or erratically and result in less effective or consistent slowing and staging of the parachute canopy deployment.

### BRIEF SUMMARY OF THE INVENTION

The applicant has discovered the parachute-opening problems such as those described above and invented an improved parachute and related opening apparatus. The improved parachute includes a generally solid body slider that is significantly lighter than prior art sliders, particularly as compared to the weight of parachute with which the slider is used. The slider is preferably made of lightweight material having at least a generally rectangular central section spanning between four relatively lightweight slider passage elements, most preferably plastic grommets or slider rings. Most preferably, the slider material is constructed of parachute fabric in the central section and may also have reinforcement material on the perimeter of the central rectangular section of the slider. In one particularly preferred and most lightweight embodiment, the slider has: (i) externally, securely mounted slider rings or suspension line passage elements rather than internally mounted grommets; and (ii) peripheral edges, which are preferably reinforced, spanning between the axial center of the slider rings.

The applicant's most preferred apparatus comprises the applicant's improved slider in conjunction with a ram-air parachute, most preferably a ram-air parachute assembly (parachute canopy, pilot chute, canopy bag, slider stops, and suspension lines) weighing two to fifteen pounds. Most preferably, this ram air parachute also utilizes the applicant's smaller pilot chute, lighter weight slider stops or stop rings, and/or slider stop suspension lines (those at the slider stop positions of the parachute) of substantially lower elasticity than that of the other suspensions lines. Most preferably, these elements can be combined not only to economically reduce the weight of the parachute, but also to provide a more properly staged, efficient, comfortable (i.e., with diminished opening shock), and reliable parachute opening, particularly that of a ram air parachute.

The applicant's preferred pilot chute on a six pound canopy preferably provides about 60 square inches, and most preferably 57 square inches, of surface area per pound of parachute assembly weight. The present pilot chute can, in certain embodiments, provide about 50% or less of the surface area of a conventional pilot chute on the same type of parachute. Most preferably, the applicant's preferred slider stop suspension lines are about 25% less elastic than the remaining suspension lines on the parachute.

There are additional aspects and features of the invention apparent from this specification. It is to be understood, therefore, that the invention is to be measured by the scope of the claims and not this Brief Summary.

### BRIEF DESCRIPTION OF THE DRAWINGS

The preferred embodiments of the present invention are shown in the accompanying drawings wherein:

FIG. 1 is a perspective view of a parachute deployed to by a skydiver suspended from the parachute, with the preferred slider shown in the deployed position on the parachute canopy above the skydiver;

FIG. 2 is a plan view of one preferred slider embodiment with the preferred grommets mounted in grommet passages adjacent, but spaced inwardly from, the four corners of the preferred slider;

FIG. 3 is a plan view of one preferred slider grommet for the internal grommet slider shown in FIG. 2;

FIG. 4 is a side cross-sectional view of the preferred grommet of FIG. 3;

FIG. 5 is plan view of a second preferred slider embodiment having slider rings, rather than grommets, mounted adjacent, but spaced externally of, the four folded corners of this preferred slider;

FIG. 6 is partial expanded plan view of one of the folded corners of the external ring slider shown in FIG. 5;

FIG. 7 is a plan view of a second preferred slider grommet for the internal grommet slider shown in FIG. 2;

FIG. 8 is a side cross-sectional view of the preferred grommet of FIG. 7;

FIG. 9 is schematic of an improperly staged parachute deployment occurring in a prior art ram air parachute with a prior art solid body rectangular slider, showing undesired slider rebound or early separation from the suspension line slider stops on the bottom side of the canopy; and

FIG. 10 is a schematic of a properly staged parachute deployment, showing the applicant's improved slider properly adjacent the suspension line slider stops immediately prior to canopy inflation.

It is to be understood that, in the accompanying Detailed Description of the Preferred Embodiments, the applicant uses terms such as “above,” “below,” “upper,” and “lower.” It is to be understood that such spacially orienting terms is for ease of description with reference to the drawings and not in themselves limiting of the orientation of the various components in space.

### DETAILED DESCRIPTION OF THE PREFERRED EMBODIMENTS

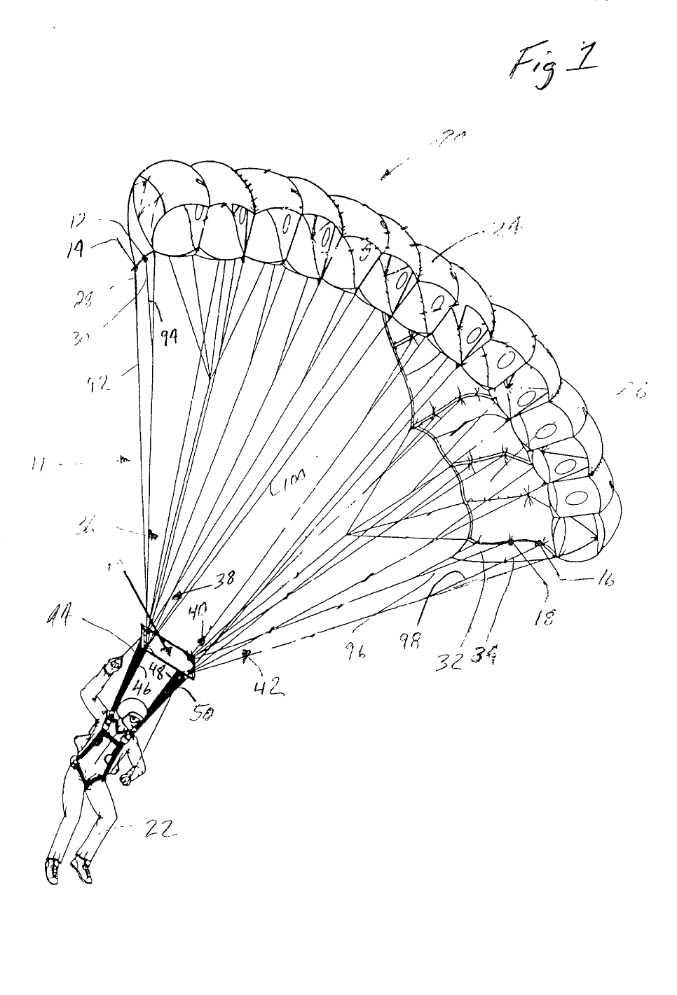

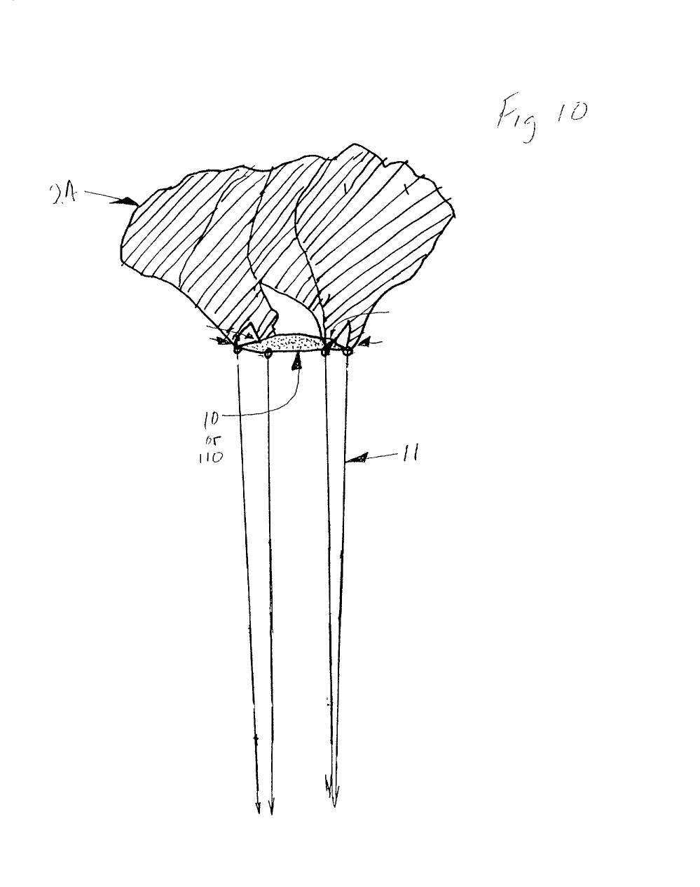

With reference now to FIG. 1, the preferred internal grommet parachute slider, generally 10, is slidably mounted on the suspension lines, generally 11, of a parachute assembly, generally 20. The applicant's most preferred parachute is the “Spectre” parachute assembly 20 manufactured by Performance Designs, Inc., of DeLand, Fla. The parachute assembly 20 generally includes a parachute canopy 24, a canopy packing bag (104 in FIG. 9), the slider 10, and suspension lines 11 in order to suspend a skydiver 22 or other object from the parachute canopy 24 above the skydiver 22 or other object (not shown) to be landed by the parachute assembly 20.

In the embodiment shown in FIG. 1, the parachute canopy 24 is a ram-air type of canopy, also commonly referred to as a “square” parachute canopy. It is to be understood that other types of canopies may also be used with the present invention, including other squares and conventional round canopies (not shown) well known to those skilled in the art.

With continuing reference to FIG. 1, the parachute assembly 20 also includes four typically metal stops or stop rings 12, 14, 16, 18 respectively secured to the underside 26 of the parachute canopy 24 at the respective junction of four outer suspension lines 28, 30, 32, 34 and the canopy underside 26. The suspension lines 11 descend downwardly from the underside 26 of the deployed canopy 24 in four groupings, generally 36, 38, 40, 42, which respectively terminate on, and are secured to, metal suspension rings (not shown) in a fashion well known to those skilled in the art. In addition, the four suspension rings are respectively secured to four suspension webs 44, 46, 48, 50, from which the skydiver 22 is securely suspended.

Today, the parachute assembly 20 (i.e., the parachute canopy 24, the suspension lines 11, the slider stops 12, 14, 16, 18, slider 10, and the accompanying canopy packing bag (not shown in FIG. 1)) most commonly weighs at least between 5 to 6 pounds (80 to 96 ounces) when the parachute assembly 20 is designed for sport or other parachuting use by a single skydiver 22. The parachute assembly can, however, weigh as little as two pounds and as much as fifteen pounds. The parachute assembly 20 may be even larger and heavier when used for multiple (e.g., tandem) skydivers 22 or larger objects (not shown).

Improved Slider:

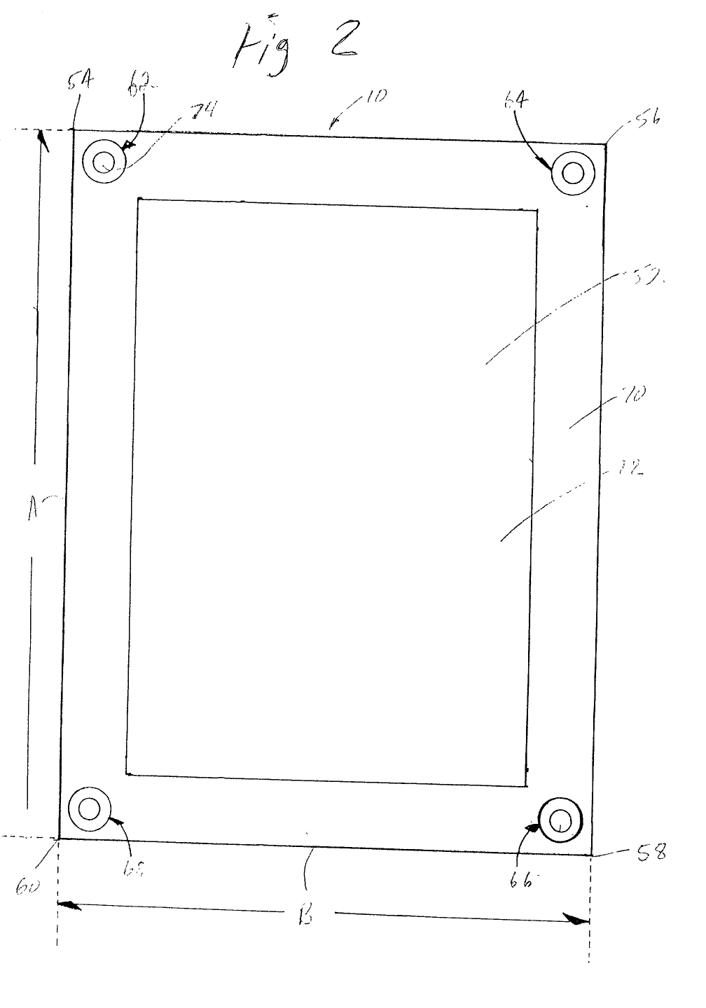

With reference now to FIG. 2, the internal grommet slider, generally 10, consists of a generally solid rectangular main body 52 and four slider grommets 62, 64, 66, 68 respectively mounted adjacent the four respective corners 54, 56, 58, 60 of the rectangular main body 52. The rectangular main body 52 consists of main body fabric 72 with perimeter reinforcing tape 70 secured, and preferably stitched to, the main body fabric 72. Preferably, the main body fabric consists of 1.2 ounce per square yard zero porocity rip stop parachute fabric; the perimeter reinforcing tape 70 consists of nylon cloth or webbing such as Bally 4001, Class 1A; and the rectangular main body 52 has a first side A that is 29 inches long and a second side B, transversely extending from the first side A, that is 22 inches long. Side A would face either, as shown in FIG. 1, the front side or back side of the skydiver 22, and side B would face the left or right side of the body of the skydiver 22.

Each of the grommets, e.g., 62, is securely mounted in grommet passages (not shown) in the main body fabric 72 in a fashion well known to those skilled in the art. Each of the grommets, e.g., 62, and associated grommet passage in the main body 52 thus cooperatively form a circular suspension line aperture or passage, e.g., 74, passing through the center of the grommet, e.g., 62, and also through the rectangular main body 52. It is these four grommets, e.g., 62, and their respective suspension line apertures, e.g., 74, through which, as shown in FIG. 1, the four respective suspension line groupings, e.g., 36, respectively pass in order to allow the slider 10 to slide down the suspension lines 11 from adjacent the underside 26 of the parachute canopy 24 and the slider stops 12, 14, 16, 18 to the abut and stop further sliding movement at the upper edge of the suspension rings (not shown) at the top of the suspension webs 44, 46, 48, 50 during the staged deployment of the parachute 20.

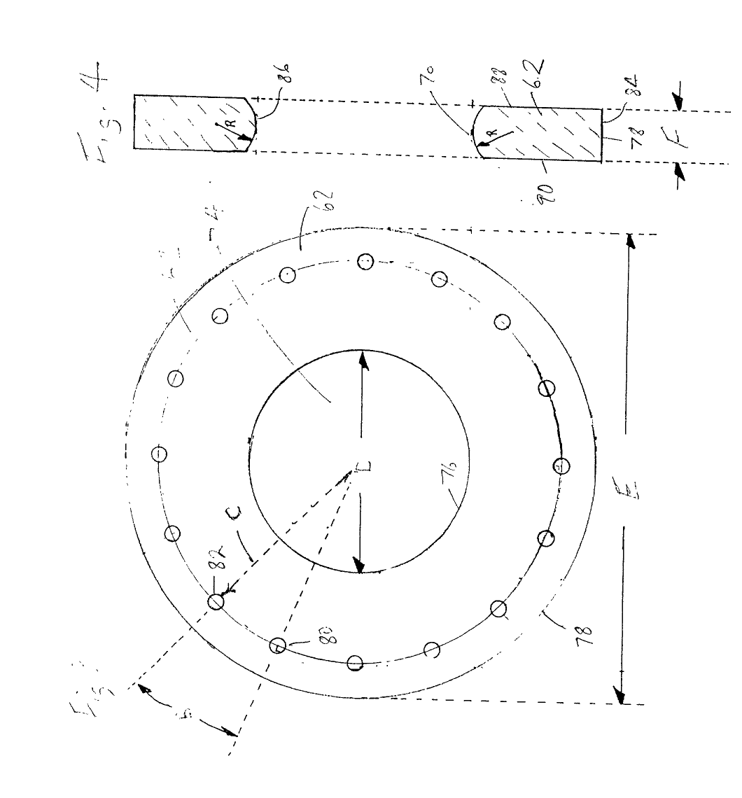

With reference now to FIG. 3, one preferred grommet 62 is shown as an example of an embodiment of the slider 10 shown in FIG. 2 in which all four grommets 62, 64, 66, 68 are preferably (although not necessarily) made of the same material and have the same shape. In this regard, each grommet, e.g., 62, is preferably made of ultra high molecular weight polyethylene (“UHMW PE”), which is relatively strong, resilient, light weight, relatively easily formed, economical, and widely available from any of a wide variety of manufacturers. Each UHMW polyethylene grommet, e.g., 62, of FIG. 1 preferably weighs 6 grams or less, and most preferably 5.3 grams or less. It is understood, however, that the grommets, e.g., 62, may be made of other materials, such as a strong yet lightweight metal like titanium or a composite synthetic or other material, and still achieve a lighter slider weight than that for prior art solid body sliders used in comparable environments as described herein. In this regard, however, the applicant prefers that the weight of any one grommet, e.g., 62, should not exceed 0.635 ounces (18 grams).

However, the applicant also believes that the dominant factor causing excessive slider rebound is the total mass at the corner locations 54, 56, 58, 60 of the preferably rectangular body 52 of the slider 10. In this regard, the applicant prefers that the total mass of a single slider passage element (in this case, a grommet, e.g., 62, and immediately adjacent main fabric body 72 (or any other construction mounted on or secured to the main fabric body 72) within a distance of 2 inches from the suspension line passage 74) should be 0.705 ounces (20 grams) or less.

These limits are for a parachute assembly 20, as shown in FIG. 1, weighing two to fifteen pounds (which, generally speaking, today typically translates to a canopy surface area of between 40 square feet and 400 square feet). For heavier weight parachutes, the minimum weights stated above would increase proportionally as compared that for the fifteen pound (or 400 square foot) canopy as stated above.

As shown in FIG. 3, a first embodiment of a preferred grommet 62 has (i) a circular outer periphery 78 with an outer periphery diameter E of 1.75 inches, and (ii) an interior suspension line passage 76 having a passage diameter D of 0.812 inches. Spaced 0.125 inches inward from the outer periphery 78 of the grommet 62 are sixteen stitching passages, e.g., 80, 82, with a radial spacing B from each other of 22.5 degrees. The sixteen stitching passages, e.g., 80, 82, are thus equally spaced adjacent the outer periphery 78 of each grommet 62 at a radial length C of 1.5 inches from the axial center of the grommet 62. The stitching passages, e.g., 80, 82, each have a diameter of 0.086 inches and are utilized to stitch the grommet 62 to, as shown in FIG. 2, the slider main body 52 in a fashion well known to those of skill in the art.

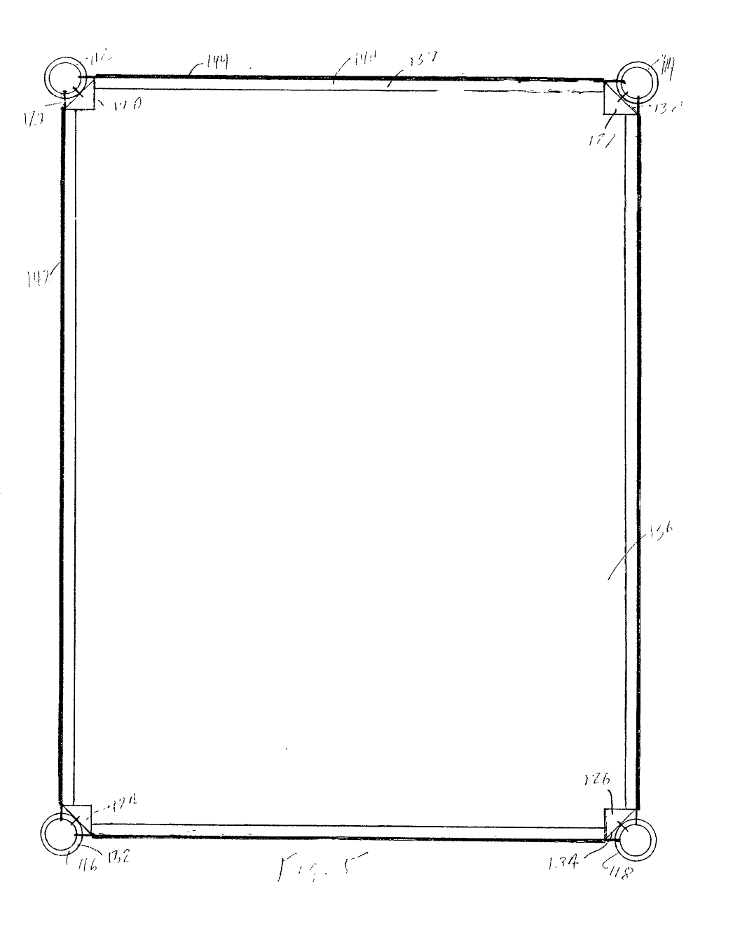

Turning now to FIG. 4, the first preferred grommet 62 for the internal grommet slider 10 of FIG. 2 has an axial thickness F of 0.2 inches and a generally planer outer peripheral side edge 84. The interior peripheral edge 86 on the interior suspension line passage 76 is rounded and has a radius R of 0.1414 inches, with the radius starting at a 45 degree angle to the upper planar side 88 and lower planar side 90 of the grommet 62.

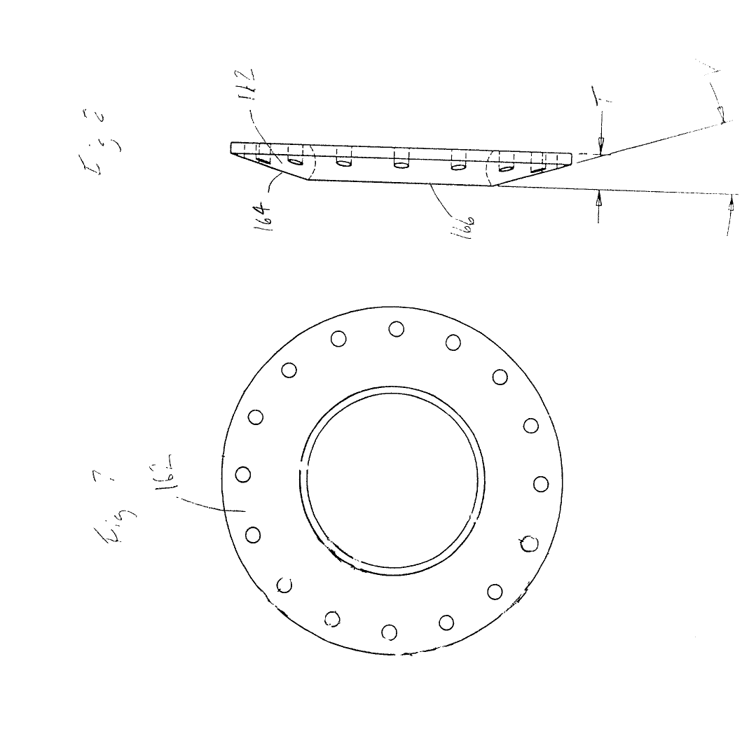

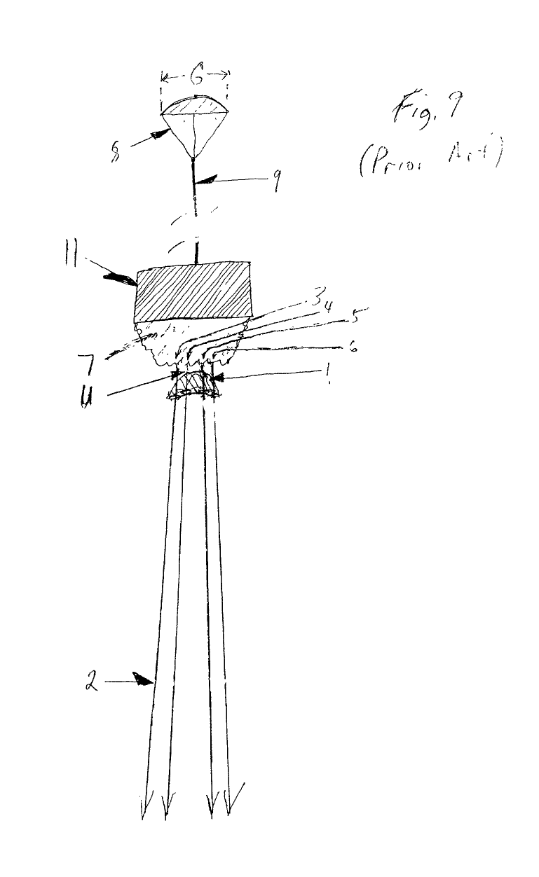

Referring now to FIG. 7, a second embodiment of a preferred grommet 162 is constructed somewhat similarly to the first preferred grommet (62 in FIG. 3) though manufactured from Delrin, a polymer manufactured by Dupont. This second grommet embodiment 162 is somewhat more rigid, stronger, and less subject to abrasion and wear than the first grommet embodiment 62. As shown in FIG. 2, this is primarily the result of the angled ring surface 164, which slopes at a 17.3 degree angle V from the upper radial surface 166 of this second grommet 162.

With reference back to FIG. 2, the internal UHMW polyethylene grommet slider 10 most preferably has a total weight of less than 3.0 ounces. This is much less than the 5 to 6 ounce (and heavier) prior art sliders typically used today with 5 to 6 pound square parachute assemblies. The applicant believes, however, that the internal grommet slider 10 may have a total weight of up to 4.5 ounces and still achieve substantial reduction in slider rebound and improvement in parachute deployment staging.

Thus, when with a parachute assembly weighing six pounds, the internal grommet slider 10 in FIGS. 2-4: preferably weighs 4.5 ounces or 4.7 percent or less of the six pound (96 ounce) weight of the parachute assembly; more preferably weighs 3.25 ounces or 3.4 percent or less of such a parachute assembly; and most preferably weighs 3 ounces or 3.1 percent or less of such a parachute assembly (20 in FIG. 1). When used with a parachute assembly weighing five pounds (80 ounces), the internal grommet slider 10 in FIGS. 2-4: preferably weighs 5.625 (4.5/80) percent or less of the five pound weight of the parachute assembly; more preferably weighs 4.063 (3.25/80) percent or less of such a parachute assembly; and most preferably weighs 3.75 (3/80) percent or less of such a parachute assembly (20 in FIG. 1).

The applicant believes, however, that the internal grommet slider 10 can be used safely and effectively with a parachute assembly weighing as little as two pounds and as much as fifteen pounds or less. For a heavier parachute assembly, the weight of the slider should increase proportionally from that described herein.

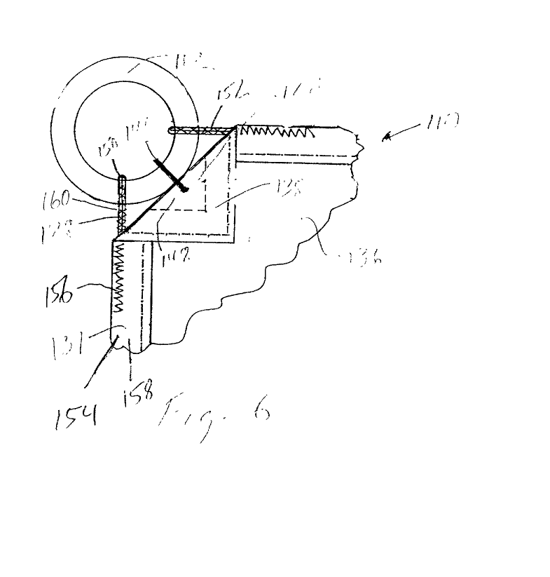

With reference now to FIGS. 5 and 6, a second preferred slider, generally 110, has four lightweight but relatively resilient, strong, and durable slider rings 112, 114, 116, 118. These slider rings 112, 114, 116, 118 are respectively secured to the outermost edges 128, 130, 132, 134 of four respective folded corners 120, 122, 124, 126 of a generally rectangular solid slider body 136. This external ring slider 110 preferably weighs 3.25 ounces or less, and more preferably weighs 2.5 ounces or less, and most preferably weighs 2.1 ounces or less (i.e., 42% or less of the weight of a 5-6 oz. prior art slider).

Each of the four slider rings 112, 114, 116, 118 is preferably made of hollow 6061-T6 aluminum tubing having an outer diameter of 0.25 inches and 0.035 inch wall thickness. The tubing is preferably formed into a ring, e.g., 112, and the tubing ends are welded together. Each finished slider ring, e.g., 112, preferably has an outer diameter of 1.5 inches and an inner diameter of 1.04 inches. Each slider ring, e.g., 112, may be anodized to provide at least a surface color for aesthetic reasons. Each slider ring, e.g., 112, preferably weighs 6 grams or less, more preferably weighs 5 grams or less, and most preferably only 4.4 grams or less (as compared to the typical 20-22 gram stainless steel or brass grommets used on typical sliders today).

With reference to FIG. 6, the slider body 136 is rectangular and preferably made of 1.2 oz. per square yard zero porosity ripstop parachute fabric. The slider body 136 can, however, be made of other fabrics or materials, including materials that are porous, provided that the slider body 136 fabric or material should preferably present substantially more surface area to the relative wind passing by the slider 110 than that presented by the X-shaped spider slider of the prior art. In addition, although the preferred slider 110 has a rectangular outer periphery, it is to be understood that the invented slider could have other outer peripheral configurations, such as those with additions or relatively minor subtractions of material from what would otherwise be a rectangular periphery and still provide at least a substantial rectangular body or central section within the confines of the non-rectangular periphery of the slider.

The outer peripheral edge, e.g., 140, of the slider body 136 is reinforced by folding the outer peripheral slider body material 137 back against the slider body 136 and stitching the folded slider material 137 to the slider body 136 from which the folded slider material 137 extends. As a result, the folded slider body material 137 and slider body 136 thus cooperatively form between them a hemmed channel or ring line passage (not shown in FIG. 5).

With reference now to FIG. 6, the folded corner 120 of the slider body 136 is formed by folding 1.125 inches (as measured radially inwardly from the folded corner 120 toward the center of the slider body 136) of the outermost corner section 138 of slider body material back on the slider body 136 and stitching the folded corner section 138 onto the main slider body 136. The resulting outermost edge 128 of the slider body 136 is thus preferably at a 45 degree angle to, as shown in FIG. 5, the adjacent, perpendicularly-extending sides or edges 142, 144 at the folded corner 120 of this external ring slider 110.

Referring back to FIG. 6, the slider ring 112 for the folded corner 120 is secured to the outermost edge 128 of the corner 120 by:

(i) a stitch tack 146, made of nylon cord, that loops around the outer periphery of the slider ring 112 and is tacked to the central area 148 of the folded corner 120 adjacent its outermost edge 128; and

(ii) two opposing ring lines 150, 152 made of Para-amid (Kevlar), Vectran, Spectra/Microline, Nylon, or Dacron/Polyester. Each such ring line, e.g., 150, loops around the outer periphery of the slider ring 112 and has opposing ends (not shown), approximately five inches long, installed in a “Chinese finger trap,” e.g., 156, formed with E thread (69) stitching in the outer edge 154 of the folded passage section 158 formed between the opposing folded slider body material 137 and the abutting section of the slider body 136. The respective ring line, e.g., 150, enters the finger trap entrance point 160 through a passage (not shown) formed in the wall of the ring line 150 by forcing a tapered needle or wire through the ring line 150 wall, thereby causing little weakening of the wall of the ring line 150. The ring line 150 should be tacked onto the finger trap 156, while under tension in an alignment fixture well known to those skilled in the art, to further secure the ring line 150 in the event of wear or loosening of the finger trap 156. The entrance point 160 of the ring line 150 into the finger trap 154 should also be tacked with a short bar-tack (not shown) well known to those skilled in the art. Finally, a confluence of nylon tape can also be installed in these stitched areas, e.g., 158, in a fashion well known to those skilled in the art, to provide stitching support and enhanced strength and durability of the resulting slider 110.

The applicant prefers to use the external ring slider 110 with ram air canopies weighing less than six pounds. The applicant believes, however, that such a slider 110 will work well with parachute assemblies of all types, including those weighing from 3 to 15 pounds. For heavier parachute assemblies, the applicant prefers to use extended ring sliders that increase proportionally in size and weight from the external ring slider disclosed herein.

With reference now to FIGS. 1, 5, and 10, both of the applicant's relatively lighter weight sliders 10, 110 provide significantly diminished “slider rebound” during parachute deployment—the undesired premature movement of the slider 10, 110 down the suspension lines 11 and away from the parachute canopy 24 toward the skydiver 22 descending below the suspension lines 11 and parachute canopy 24 during deployment of the parachute assembly 20. As a result of the reduced slider rebound, during deployment the sliders, 10 or 110, are less likely to move down the suspension lines 11 away from the parachute canopy 24 and its associate slider stops 12, 14, 16, 18, until after the canopy 24 has come well out of the canopy deployment bag (not shown in FIG. 10), which takes place after the suspension lines 11 have unstowed, typically, from stowing apparatus (not shown) mounted on the deployment bag. It is at this point that the parachute canopy 24 is ready to commence opening in a properly staged fashion by, among other things, forcing the slider, 10 or 110, away from the slider stops 12, 14, 16, 18 downwardly on the suspension lines 11 toward the suspension rings (not shown) above the skydiver 22.

This reduction in slider rebound and improved parachute deployment staging results in a slower canopy opening and reduced opening shock for the skydiver 22. It also results in reduced likelihood of parachute assembly malfunction (such as suspension line-over-the-canopy malfunctions) and thus a significantly more reliable and safe opening of the entire parachute assembly 20 for the skydiver 22.

It should also be noted that the relatively lower weight slider, 10 or 110, also reduces the amount of force, impact, and wear imposed by the slider, 10 or 100, and its respective associate grommets, e.g., 62, or slider rings, e.g., 112, against the slider stops 12, 14, 16, 18. As a result, the preferred parachute assembly 20 can reliably utilize lower weight and more economical slider stops 12, 14, 16, 18 than those typically used in prior art parachute assemblies. In the preferred ram air parachute of FIG. 1, the slider stops, e.g. 12, are made of lightweight UHMW polyethylene, weighing 2.25 grams per stop 12, rather than stainless steel, weighing 8 grams per stop, as is common in the prior art.

With reference now to FIG. 6, it should be noted that the applicant's external ring slider 110 provides significantly less weight, and thus less slider rebound and more improved deployment staging, etc., for a given parachute assembly 20, than the applicant's internal grommet slider 10 of FIGS. 3 and 4 for example. In addition, the axial centers of slider rings, e.g., 112, on the external ring slider 110 respectively intersect the line of the outermost edges, e.g., 142, 144, respectively adjacent the respective slider rings, e.g., 112. In contrast to the internally mounted grommets, e.g., 62, of the internal grommet slider 10, the externally or peripherally mounted slider rings 112, 114, 116, 118 on the external ring slider 110 place the entire slider body 136 of the external ring slider 110, including its outermost sides or edges, e.g., 142, in tension during the parachute-deployment canopy opening phase (during which the slider 110 is forced to slide down the suspension lines). The external ring slider 110 is also more likely to inflate faster than internal grommet sliders, particularly the heavier such sliders in the prior art.

As a result, during this phase, the peripheral ring slider 110 more effectively presents the entire surface area of the slider body 136 under tension between the four suspension line groupings 36, 38, 40, 42 and against the relative wind passing by the slider 110. The peripheral or external ring slider 110 is therefore generally more effective than prior art sliders and internal grommet sliders, e.g., 10, at: (i) providing optimum resistance of the slider 110 to the relative wind during the canopy opening phase, (ii) providing proper staging, and minimizing of malfunctions, during the canopy opening phase, and (iii) reducing opening shock or the frequency of hard openings (i.e, openings with relatively high levels of opening shock).

Improved Suspension Lines:

Referring now to FIGS. 1,2, and 5, the applicant has discovered that the parachute assembly 20 can be improved by employing suspension lines 22 at the slider stops 12, 14, 16, 18 (the “stop suspension lines” 92, 94, 96, 98) that are relatively less elastic than the other suspension lines, e.g., 100. The applicant believes that, with slider stop suspension lines, e.g., 92, of relatively lower elasticity, such suspension lines convert more of the energy of the slider 10 or 110 applied to such stop suspension lines, e.g., 92, into heat (commencing immediately after the last suspension line stow release occurs during deployment, thereby slowing and more properly staging the opening the parachute assembly 20. In any event, the applicant has discovered that use of such relatively less elastic slider stop suspension lines 92, 94, 96, 98 results in reduced opening shock and improved staging of the cooperative deployment of the parachute assembly 20 and slider 10.

In the preferred embodiment of FIG. 1, the slider stop suspension line 92, 94, 96, 98 are made of either nylon or Dacron/polyester manufactured by DuPont. The other suspension lines 22 are made of significantly more elastic lines, such as Spectra/Microline manufactured by Allied Signal, Honeywell International, or Performance Fibers, Para-aramid manufactured by DuPont, or Vactran manfuctured by the Celanese Acetate Division of Hoechst. In this regard, the nylon line described above is about 25% less elastic than Spectra/Microline, and the Dacron/polyester line described above is about 10% less elastic than Spectra/Microline.

Improved Pilot Chute:

The applicant has also discovered that yet another factor contributing to excessive opening shock, and increased slider rebound, is the use of pilot chute that is too large. Referring now to FIG. 9, in sport parachuting today, the parachute assembly 20 is pulled off of the back of the skydiver (not shown in FIG. 9) during deployment by means of a soft, foldable pilot chute 8, which the skydiver typically deploys today by pulling the pilot chute 8 out of a pocket (not shown) and releases into the air streaming by the skydiver during free fall. These pilot chutes 8 typically have a pilot chute diameter G of at least 25 inches across when used with, as shown in FIG. 1, a canopy assembly 20 weighing two to fifteen pounds, and typically is significantly larger when used with a substantially larger canopy assembly.

The applicant has discovered that this type of pilot chute 8 can be significantly reduced in size as compared to the weight of the canopy assembly 20, which not only reduces the weight of the pilot chute 8 but also slows down the deployment of the canopy assembly 20 to a degree having a positive impact in reducing slider rebound, opening shock, and malfunction occurrence, while opening rapidly enough to have little effect on overall opening time and safety of the parachute assembly 20 for use in safely land the skydiver. The applicant's most preferred pilot chute 8 for a sport parachuting ram-air canopy assembly weighing two to fifteen pounds is thus made of the same fabrics, with the same relative construction configuration and assembly technique, as those of conventional prior art pilot chutes (such as use of 1.2 ounce per square yard zero porosity ripstop fabric for the pilot chute canopy), but has a deployed pilot chute area of no more than 60 square inches per pound of canopy weight as opposed to prior art pilot chute areas that are commonly 80 or more square inches per pound of canopy weight.

For example, a prior art 26 inch diameter soft pilot chute 8 with a six pound canopy results in a deployed pilot chute cross-sectional area of 88 square inches per pound of canopy. With a six pound parachute, however, the applicant preferably uses approximately a 21 inch diameter pilot chute, which translates to a little less than 60 square inches of pilot chute area per pound of canopy. It is to be understood that the term “pilot chute area” is the typically circular section of pilot chute canopy material spanning the widest part of the pilot chute when laid flat on a flat surface. This calculated area is based on a pilot chute “diameter” commonly referred to by those skilled in the art as the pilot chute's “skirt-apex-skirt” measurement (the actual flat fabric diameter).

It should be noted that the preferred pilot chute 8 not only utilizes less material than is typically utilized in ram air parachuting today, but also is effective yet less costly to manufacture and, particularly in the applicant's preferred combination, results in a lighter parachute than the parachutes in the prior art. In this regard, the applicant's most preferred 21 inch diameter pilot chute 8 described above weighs 2.2 ounces as compared to the prior and common 30 inch pilot chute which typically weighs 2.6 ounces or more.

Additional Advantages of the Preferred Embodiments

It can thus be seen that the preferred embodiments provide lighter weight parachutes. They also render the entire parachute and all of its associated components, as well as those carried by the skydiver or other object to be descended with the parachute, significantly less likely to suffer damage and more likely to last substantially longer. In addition, they can be very economical and relatively strong and long lasting, and they are easy to manufacture and use.

It should also be understood that, although the applicant has above described various embodiments as being used in conjunction with two to fifteen pound parachute assemblies, the various embodiments may also even more preferably be utilized with parachute assemblies weighing four to ten pounds and most preferably be used with parachute assemblies weighing five to six and one-half pounds, which are the most commonly used sport parachutes in use today.

It should also be understood that the foregoing constitutes a detailed description of the preferred embodiments. The scope of the invention, however, is to be determined by the accompanying claims.

What I claimed is:

1. An improved parachute comprising in combination:
A. a canopy assembly weighing two to fifteen pounds, said canopy assembly including a canopy body, slider stops, a canopy bag, and suspension lines:
B. a parachute slider with at least a generally rectangular lightweight fabric slider body portion having (i) four corner portions; and (ii) at least four lightweight strong slider suspension line aperture elements, one of said four slider suspension line aperture elements being mounted adjacent one of said four corner portions, each of said slider suspension line aperture elements weighing 20 grams or less, and said parachute slider weighing less than 4.5 ounces, said parachute slider being mounted on a plurality of said suspension lines of said canopy assembly in order to slide down the plurality of suspension lines during deployment of said canopy assembly and to thereby stage the deployment of said canopy assembly.

2. The improved parachute of claim 1 wherein each of said slider suspension line aperture elements weighs 6 grams or less.

3. The improved parachute of claim 1 wherein each of said slider suspension line elements weighs 5.5 grams or less and the improved parachute slider weighs 3.3 ounces or less.

4. The improved parachute of claim 1 wherein each of said slider suspension line elements weighs 4.5 grams or less and the improved parachute slider weighs 2.5 ounces or less.

5. The improved parachute of claim 1 wherein each of said slider suspension line elements weighs 4.5 grams or less and the improved parachute slider weighs 2.1 ounces or less.

6. The improved parachute of claim 5 wherein the parachute slider also has four lightweight resilient slider reinforcement sections spanning between two opposing sides of said fabric slider body on an external peripheral edge of the fabric slider body.

7. The improved parachute of claim 1 wherein each said slider suspension line aperture element comprises a grommet mounted in a grommet aperture in the fabric slider body.

8. The improved parachute of claim 5 wherein each said slider suspension line aperture element comprises a grommet mounted in a grommet aperture in the fabric slider body.

9. The improved parachute of claim 8 wherein each said slider suspension line aperture element is made of a lightweight polymeric material such as ultra high molecular weight polyethylene.

10. The improved parachute of claim 6 wherein each slider reinforcement section comprises an external edge portion of the fabric slider body folded and secured to a central section of the fabric slider body.

11. The improved parachute of claim 7 wherein each said slider suspension line aperture element is secured to, and extends externally of, the fabric slider body.

12. The improved parachute of claim II wherein the slider suspension line aperture element has an axial center intersecting the plane of the slider reinforcement section, whereby the suspension line aperture element distributes opening force to the fabric slider body along the slider reinforcement section.

13. An improved parachute slider of the type for staging the deployment of a parachute, the parachute having a canopy including a canopy body and suspension lines, the parachute slider being mounted on a plurality of suspension lines in order to slide down the plurality of suspension lines during deployment of the parachute, the improved parachute slider comprising:
A. a fabric slider body having at least a generally rectangular central section with four corner sections; and
B. four suspension line sliding elements, each said suspension line sliding element having a suspension line aperture passing through said suspension line sliding element and being secured adjacent one of said four corner sections to extend outwardly from the fabric slider body generally within the plane of the fabric slider body.

14. The improved parachute slider of claim 1 wherein each suspension line sliding element comprises a rigid slider ring secured to the fabric slider body adjacent the outer edge of the fabric slider body externally of the fabric slider body.

15. The improved parachute slider of claim 13 also having (C): four lightweight resilient slider reinforcement sections spanning between two opposing sides of said fabric slider body on an external peripheral edge of the fabric slider body.

16. The improved parachute slider of claim 15 wherein each said rigid slider ring is made of metal.

17. The improved parachute slider of claim 15 wherein each slider reinforcement section comprises an external edge portion of the fabric slider body folded and secured to a central section of the fabric slider body.

18. The improved parachute slider of claim 13 wherein the slider suspension line aperture element has an axial center intersecting the plane of the slider reinforcement section, whereby the suspension line aperture element distributes opening force to the fabric slider body along the slider reinforcement section.

19. The improved parachute slider of claim 17 wherein the slider suspension line aperture element has an axial center intersecting the plane of the slider reinforcement section, whereby the suspension line aperture element distributes opening force to the fabric slider body along the slider reinforcement section.

20. The improved parachute slider of claim 13 wherein the slider weighs 3.25 ounces or less.

21. The improved parachute slider of claim 18 wherein the slider weighs 2.5 ounces or less.

22. The improved parachute slider of claim 19 wherein the slider weighs 2.1 ounces or less.

23. The improved parachute slider of claim 22 wherein the rigid slider ring is made of aluminum.

24. An improved parachute of the type used to deploy and land an object suspended by the parachute assembly, the parachute assembly weighing between two and fifteen pounds and comprising in combination:
A. a main canopy having slider stops secured adjacent thereto;
B. suspension lines secured to the main canopy whereby the suspension lines may suspend the object under the canopy when deployed, said suspension lines including (i) slider stop suspension lines, each said slider stop suspension line abutting one of said slider stops, and (ii) stopless suspension lines;
C. a parachute slider having at least a generally rectangular central body section, said parachute slider being mounted on the slider stop suspension lines whereby the slider may slide down the slider stop suspension lines during deployment of the improved parachute, the parachute slider weighing 4.5 ounces or less;
D. a pilot chute mounted on the canopy and having a pilot chute canopy with an area of 60 square inches or less per pound of parachute assembly.

25. The improved parachute of claim 24 wherein the pilot chute canopy has an area of 57 inches or less per pound of canopy weight.

26. The improved parachute of claim 24 wherein the pilot chute canopy has a diameter of 21.5 inches or less.

27. The improved parachute of claim 25 wherein the pilot chute canopy has a diameter of 21.5 inches or less.

28. The improved parachute of claim 23 wherein the parachute slider weighs 3.25 ounces or less.

29. The improved parachute of claim 23 wherein the parachute slider weighs 2.5 ounces or less.

30. The improved parachute of claim 26 wherein the parachute slider weights 2.1 ounces or less.

31. The improved parachute of claim 24 wherein the slider stop suspension lines are substantially less elastic than the stopless suspension lines.

32. An improved parachute of the type used to deploy and land an object suspended by the parachute assembly, the parachute assembly weighing between between three and fifteen pounds and comprising in combination:
A. a main canopy having slider stops secured adjacent thereto;
B. suspension lines secured to the main canopy whereby the suspension lines may suspend the object under the canopy when deployed, said suspension lines including (i) slider stop suspension lines abutting one of said slider stops and (ii) stopless suspension lines, said slider stop suspension lines being substantially less elastic that said stopless suspension lines;
C. a parachute slider having at least a rectangular central body section and being mounted on the slider stop suspension lines whereby the slider may slide down the slider stop suspension lines during deployment of the improved parachute, the parachute slider weighing 4.5 ounces or less; and
D. a main canopy bag and pilot chute canopy secured to the main canopy.

33. The improved parachute of claim 24 wherein the pilot chute canopy has an area of 60 inches or less per pound of parachute assembly.

34. The improved parachute of claim 33 wherein the pilot chute canopy has an area of 57 square inches or less per pound of parachute assembly.

35. The improved parachute of claim 33 wherein the parachute slider weighs 3.25 ounces or less.

36. The improved parachute of claim 33 wherein the parachute slider weighs 2.5 ounces or less.

37. The improved parachute of claim 26 wherein the parachute slider weights 2.1 ounces or less.

38. The improved parachute of claim 34 wherein the parachute slider weighs 2.1 ounces or less.

39. The improved parachute of claim 32 wherein the parachute slider comprises a fabric slider body and a plurality of slider rings secured to the fabric slider body to extend from the edge of the fabric slider body radially outwardly from the center of the fabric slider body.

40. The improved parachute of claim 32 wherein the parachute slider comprises a fabric slider body with a plurality of lightweight resilient grommets mounted in grommet apertures in the fabric slider body.

41. The improved parachute of claim 39 wherein the parachute slider also has a plurality of reinforced edges comprising fabric slider body material folded and secured to the fabric slider body.
